(19) United States
(12) Patent Application Publication
(10) Pub. No.: US 2022/0033538 A1
(43) Pub. Date: Feb. 3, 2022

(54) ORGANIC-INORGANIC COMPOSITE HYDROGEL PRECURSOR COMPOSITION, AND ORGANIC-INORGANIC COMPOSITE HYDROGEL

(71) Applicant: DIC Corporation, Tokyo (JP)

(72) Inventors: Mitsuyuki Kanzaki, Takaishi-shi (JP); Norio Nishimura, Takaishi-shi (JP); Rie Yamasaki, Takaishi-shi (JP)

(73) Assignee: DIC Corporation, Tokyo (JP)

(21) Appl. No.: 17/297,715

(22) PCT Filed: Dec. 3, 2019
(86) PCT No.: PCT/JP2019/047150

§ 371 Date: May 27, 2021

(30) Foreign Application Priority Data
Dec. 17, 2018 (JP) 2018-235419

(51) Int. Cl. C08F 2/44; C08F 251/02

(52) U.S. Cl. CPC C08F 2/44; C08F 251/02

(57) ABSTRACT

Provided is an organic-inorganic composite hydrogel precursor composition characterized by including a water-soluble organic monomer (A), a phosphonic acid-modified hectorite (B), cellulose nanofibers (C), water (D), and a solvent (E) having a volatility of 0.1 g or less per cm²·hr in an open system at 60° C., 1 atm (0.1 g/cm²·hr·60° C.·1 atm or less). The organic-inorganic composite hydrogel precursor composition has excellent storage stability and curability in water, exhibits little change in mass even under open-air conditions, makes it easy to obtain a hydrogel having excellent mechanical properties and, therefore, can be applied to various industrial uses such as at civil engineering work sites.

### TECHNICAL FIELD

The present invention relates to an organic-inorganic composite hydrogel precursor composition and an organic-inorganic composite hydrogel.

### BACKGROUND ART

A gel has properties between those of a liquid and those of a solid, in which a substance such as an organic polymer forms a three-dimensional network in a solvent such as water, and is in a stable state. In particular, gels in which the solvent is water are referred to as hydrogels, and applications thereof as functional materials, for example, in the medical, food, and sport-related fields, have been developed. In particular, in order to impart uniform transparency, strong mechanical properties, water absorption capacity, biocompatibility, and the like, compounding with various materials and devising of crosslinked structures have been performed.

For example, there is described an invention relating to an organic-inorganic composite hydrogel in which water is included in a three-dimensional network formed by compounding a water-soluble organic polymer and a water-swellable clay mineral (for example, refer to PTL 1). According to the organic-inorganic composite hydrogel described in PTL 1, it is stated that it is possible to achieve a light transmittance of 95% or more, a water absorption capacity 10 or more times its dry weight, and an elongation as high as 10 or more times.

Furthermore, there is proposed a filler for a concrete structure including an organic-inorganic composite hydrogel (for example, refer to PTL 2). When used as a filler for a concrete structure, high adhesion to concrete is often required, and it has been demanded to improve the mechanical strength of the filler.

Furthermore, when used as a filler for a concrete structure, for example, the filler may be used as a water stopping material to stop leakage of water. In this case, the filler is often used at construction sites and repair sites of concrete structures, and storage stability and curability in water as the filler have been demanded. Furthermore, in existing hydrogels, there has been a problem in that when water is evaporated under open-air conditions, the hydrogels are finally changed into brittle materials.

Accordingly, there has been a demand for a material that exhibits little change in viscosity, has excellent storage stability, exhibits little change in mass, and is capable of forming a hydrogel having excellent mechanical properties.

### CITATION LIST

### Patent Literature

PTL 1: Japanese Unexamined Patent Application Publication No. 2001-158634

PTL 2: Japanese Unexamined Patent Application Publication No. 2017-186182

### SUMMARY OF INVENTION

### Technical Problem

A technical problem of the present invention is to provide a composition that has excellent storage stability and curability in water, exhibits little change in mass even under open-air conditions, and is capable of forming a hydrogel having excellent mechanical properties.

### Solution to Problem

The present inventors have found that the problem can be solved by an organic-inorganic composite hydrogel precursor solution which includes a water-soluble organic monomer, phosphonic hectorite, cellulose nanofibers, water, and a specific solvent, thus completing the present invention.

That is, the present invention provides an organic-inorganic composite hydrogel precursor composition characterized by including a water-soluble organic monomer (A), a phosphonic acid-modified hectorite (B), cellulose nanofibers (C), water (D), and a solvent (E) having a volatility of 0.1 g or less per cm²·hr in an open system at 60° C., 1 atm (0.1 g/cm²·hr·60° C.·1 atm or less).

### Advantageous Effects of Invention

The organic-inorganic composite hydrogel precursor composition according to the present invention has excellent storage stability and curability in water, exhibits little change in mass even under open-air conditions, makes it easy to obtain a hydrogel having excellent mechanical properties and, therefore, can be applied to various industrial uses such as at civil engineering work sites. Description of Embodiments

An organic-inorganic composite hydrogel precursor composition according to the present invention includes a water-soluble organic monomer (A), a phosphonic acid-modified hectorite (B), cellulose nanofibers (C), water (D), and a solvent (E) having a volatility of 0.1 g or less per cm²·hr in an open system at 60° C., 1 atm (0.1 g/cm²·hr·60° C.·1 atm or less).

Examples of the water-soluble organic monomer (A) include a monomer having a (meth)acrylamide group, a monomer having a (meth)acryloyloxy group, and a (meth)acrylic monomer having a hydroxyl group.

In the present invention, “(meth)acrylamide” refers to one or both of acrylamide and methacrylamide, “(meth)acryloyloxy” refers to one or both of acryloyloxy and (meth)acryloyloxy, “(meth)acrylate” refers to one or both of acrylate and methacrylate, and “(meth)acrylic monomer” refers to one or both of acrylic monomer and methacrylic monomer.

Example of the monomer having a (meth)acrylamide group include (meth)acrylamide, N,N-dimethyl(meth)acrylamide, N,N-diethyl(meth)acrylamide, N-methyl(meth)acrylamide, N-ethyl(meth)acrylamide, N-isopropyl(meth)acrylamide, N-cyclopropyl(meth)acrylamide, N,N-dimethylaminopropyl(meth)acrylamide, N,N-diethylaminopropyl(meth)acrylamide, (meth)acryloylmorpholine, and N,N′-methylenebis(meth)acrylamide.

Examples of the monomer having a (meth)acryloyloxy group include methoxyethyl(meth)acrylate, ethoxyethyl(meth)acrylate, methoxymethyl(meth)acrylate, ethoxymethyl(meth)acrylate, polyethylene glycol mono(meth)acrylate, and polyethylene glycol di(meth)acrylate.

Examples of the (meth)acrylic monomer having a hydroxyl group include hydroxyethyl(meth)acrylate.

Among these, from the viewpoints of solubility and adhesion to substrate and mechanical properties of the resulting organic-inorganic composite hydrogel, it is preferable to use a monomer having a (meth)acrylamide group, it is more preferable to use (meth)acrylamide, N,N-dimethyl(meth)acrylamide, N,N-diethyl(meth)acrylamide, N-isopropyl(meth)acrylamide, and (meth)acryloylmorpholine, it is still more preferable to use N,N-dimethyl(meth)acrylamide and (meth)acryloylmorpholine are used, and from the viewpoint that polymerization easily proceeds, it is particularly preferable to use N,N-dimethyl(meth)acrylamide.

Moreover, from the viewpoint of further improvement in mechanical properties, such as water pressure resistance, of an organic-inorganic composite hydrogel, combined use with a multifunctional monomer, such as N,N′-methylenebis(meth)acrylamide or polyethylene glycol di(meth)acrylate, is preferable, and combined use with N,N′-methylenebis(meth)acrylamide is more preferable.

From the viewpoint of mechanical properties, such as water pressure resistance, of an organic-inorganic composite hydrogel, the multifunctional monomer is used in an amount preferably in a range of 0.01 to 0.5% by mass, more preferably in a range of 0.03 to 0.3% by mass, in the raw material monomer.

The phosphonic acid-modified hectorite (B), together with a polymer of the water-soluble organic monomer, forms a three-dimensional network structure and serves as a constituent for an organic-inorganic hydrogel.

Examples of the phosphonic acid-modified hectorite (B) that can be used include a pyrophosphoric acid-modified hectorite, an etidronic acid-modified hectorite, an alendronic acid-modified hectorite, a methylenediphosphonic acid-modified hectorite, and a phytic acid-modified hectorite. As these phosphonic acid-modified hectorites, those naturally occurring, those synthesized, those surface-modified, or the like can be used. From the viewpoint of strength and adhesion of the resulting organic-inorganic composite hydrogel, use of a phosphonic acid-modified synthetic hectorite is preferable. These phosphonic acid-modified hectorites may be used alone or in combination of two or more.

The organic-inorganic composite hydrogel precursor composition according to the present invention can include a water-swellable clay mineral other than the phosphonic acid-modified hectorite (B) within the range not impairing the effects of the present invention, such as storage stability.

Since the organic-inorganic composite hydrogel precursor composition according to the present invention includes the cellulose nanofibers (C), excellent storage stability is achieved.

The cellulose nanofibers (C) are obtained by fibrillation and/or refinement of various types of cellulose.

Examples of the cellulose that can be used include pulp; cotton; paper; regenerated cellulose fibers, such as rayon, cupra, polynosic, and acetate; bacteria-produced cellulose; and animal-derived cellulose, such as ascidian. Furthermore, these celluloses may be chemically surface-modified as necessary.

Fibrillation and/or refinement of the cellulose nanofibers (C) can be performed, for example, by adding cellulose in water or a fibrillation resin such as a polyester resin and mechanically applying a shearing force thereto.

Examples of the means for applying a shearing force that can be used include a bead mill, an ultrasonic homogenizer, an extruder such as a single-screw extruder or a twin-screw extruder, and a known kneader such as a Banbury mixer, a grinder, a pressure kneader, or a twin roll. Note that these means may be used alone or in combination of two or more.

Furthermore, the cellulose nanofibers (C) may be modified cellulose nanofibers which are obtained by producing cellulose nanofibers by fibrillation and/or refinement of cellulose, followed by further adding and allowing a modifying compound to react with the cellulose nanofibers.

Examples of the modifying compound include compounds which chemically bind a functional group, such as an alkyl group, an acyl group, an acylamino group, a cyano group, an alkoxy group, an aryl group, an amino group, an aryloxy group, a silyl group, or a carboxyl group, with and modify the cellulose nanofibers.

Furthermore, rather than chemically binding, the modifying compound may physically adsorb and modify the cellulose nanofibers. Examples of the physically adsorbing compound include surfactants, which may be anionic, cationic, or nonionic.

The fiber diameter and fiber aspect ratio of the cellulose nanofibers (C) are not particularly limited, but the fiber diameter is preferably 1,000 nm or less, and more preferably 100 nm or less.

Examples of the commercially available product of the cellulose nanofibers (C) include “Cellish” manufactured by Daicel FineChem Ltd., “RHEOCRYSTA” manufactured by DKS Co. Ltd., “BiNFi-s” manufactured by Sugino Machine Limited, and “cellenpia” manufactured by Nippon Paper Industries Co., Ltd.

As the solvent (E), a solvent having a volatility of 0.1 g or less per cm²·hr in an open system at 60° C., 1 atm (0.1 g/cm²·hr·60° C.·1 atm or less) is used. A solvent preferably having a volatility of 0.05 g or less, more preferably 0.01 g or less, is used. Specifically, since a solvent that is easily miscible with water is desirable, polyhydric alcohols, such as glycerin (0.001 g/cm²·hr·60° C.·1 atm or less), diglycerin (0.001 g/cm²·hr·60° C.·1 atm or less), ethylene glycol (0.01 g/cm²·hr·60° C.·1 atm or less), propylene glycol (0.001 g/cm²·hr·60° C.·1 atm or less), and polyethylene glycol (0.001 g/cm²·hr·60° C.·1 atm or less), are preferable, and glycerin and diglycerin are more preferable. These low-volatility solvents may be used alone or in combination of two or more. Furthermore, it is desirable that these low-volatility solvents be homogeneously contained in an organic-inorganic composite hydrogel of the present invention.

The content of the water-soluble organic monomer (A) in the organic-inorganic composite hydrogel precursor composition of the present invention is preferably 1 to 50% by mass, and more preferably 5 to 30% by mass. When the content of the water-soluble organic monomer (A) is 1% by mass or more, a hydrogel having excellent mechanical properties can be obtained, which is preferable. On the other hand, when the content of the water-soluble organic monomer is 50% by mass or less, the composition can be easily prepared, which is preferable.

From the viewpoint that mechanical properties of the resulting hydrogel are further improved, the content of the phosphonic acid-modified hectorite (B) in the organic-inorganic composite hydrogel precursor composition of the present invention is preferably 1% by mass or more, and more preferably 2% by mass or more. On the other hand, from the viewpoint that an increase in the viscosity of the composition can be further suppressed, the content is preferably 20% by mass or less, and more preferably 10% by mass or less.

The content of the cellulose nanofibers (C) in the organic-inorganic composite hydrogel precursor composition of the present invention is preferably 0.1 to 50% by mass, more preferably 0.5 to 30% by mass, and still more preferably 1 to 20% by mass. When the content of the cellulose nanofibers is 0.1% or more, excellent storage stability is achieved, which is preferable. On the other hand, when the content of the cellulose nanofibers is 50% by mass or less, the precursor composition can be easily prepared, which is preferable.

From the viewpoint that it is possible to obtain an organic-inorganic hydrogel which exhibits little change in mass even under open-air conditions and has excellent mechanical properties such as water pressure resistance, the mass ratio (D/E) of the water (D) to the solvent (E) in the organic-inorganic composite hydrogel precursor composition of the present invention is preferably in the range of 60/40 to 20/80, and more preferably in the range of 50/50 to 30/70.

The organic-inorganic composite hydrogel precursor composition of the present invention can be obtained, for example, by adding the cellulose nanofibers (C) to a mixture of the water-soluble organic monomer (A), the modified hectorite (B), water (D), and the solvent (E).

As a method of producing an organic-inorganic composite hydrogel according to the present invention, from the viewpoint that an organic-inorganic composite hydrogel having a three-dimensional network structure can be obtained simply and easily, preferable is a method in which the water-soluble organic monomer (A) is polymerized in a dispersion (X) which includes the organic-inorganic composite hydrogel precursor composition, a polymerization initiator (F), and a polymerization promotor (G). The resulting polymer of the water-soluble organic monomer, together with a water-swellable clay mineral, forms a three-dimensional network structure and serves as a constituent of an organic-inorganic composite hydrogel.

Examples of the polymerization initiator (F) include, but not particularly limited to, a water-soluble peroxide and a water-soluble azo compound.

Examples of the water-soluble peroxide include potassium peroxodisulfate, ammonium peroxodisulfate, sodium peroxodisulfate, and t-butyl hydroperoxide.

Examples of the water-soluble azo compound include 2,2′-azobis(2-methylpropionamidine) dihydrochloride and 4,4′-azobis(4-cyanovaleric acid).

Among these, from the viewpoint of interaction with the phosphonic acid-modified hectorite (B), a water-soluble peroxide is preferably used; potassium peroxodisulfate, ammonium peroxodisulfate, and sodium peroxodisulfate are more preferably used; and sodium peroxodisulfate and ammonium peroxodisulfate are still more preferably used.

Note that the polymerization initiator (F) may be used alone, or two or more polymerization initiators may be used in combination.

From the viewpoint that polymerization of the water-soluble organic monomer (A) is allowed to sufficiently proceed even in water or in an air atmosphere, the molar ratio (F/A) or the polymerization initiator (F) to the water-soluble organic monomer (A) in the dispersion (X) is preferably 0.0025 or more, more preferably 0.005 to 0.04, and still more preferably 0.01 to 0.02.

Examples of the polymerization promotor (G) include tertiary amine compounds, thiosulfates, and ascorbic acids.

Examples of the tertiary amine compounds include N,N,N′,N′-tetramethylethylenediamine and 3-dimethylaminopropionitrile.

Examples of the thiosulfates include sodium thiosulfate and ammonium thiosulfate.

Examples of the ascorbic acids include L-ascorbic acid and sodium L-ascorbate.

Among these, from the viewpoints of affinity and interaction with a water-swellable clay mineral, it is preferable to use a tertiary amine compound, and it is more preferable to use N,N,N′,N′-tetramethylethylenediamine.

Note that the polymerization promotor (G) may be used alone, or two or more polymerization promotors may be used in combination.

In the case where a polymerization promotor is used, the content of the polymerization promotor (G) in the dispersion (X) is preferably 0.01 to 1% by mass, and more preferably 0.05 to 0.5% by mass. When the content of the polymerization promotor is 0.01% by mass or more, it is possible to efficiently promote synthesis of an organic monomer of the resulting hydrogel, which is preferable. On the other hand, when the content of the polymerization promotor is 1% by mass or less, the dispersion can be used without aggregation before polymerization, thus improving handling properties, which is preferable.

The dispersion (X) may include, as necessary, an organic solvent other than the solvent (E), an organic crosslinking agent, an antiseptic agent, a thickening agent, and the like.

Examples of the organic solvent include alcohol compounds, such as methanol, ethanol, propanol, isopropyl alcohol, and 1-butanol; ether compounds, such as ethyl ether and ethylene glycol monoethyl ether; amide compounds, such as dimethylformamide and N-methyl pyrrolidone; and ketone compounds, such as acetone and methyl ethyl ketone.

Among these, from the viewpoint of dispersibility of a water-swellable clay mineral, an alcohol compound is preferably used; methanol, ethanol, n-propyl alcohol, and isopropyl alcohol are more preferably used; and methanol and ethanol are still more preferably used.

Note that these organic solvents may be used alone or in combination of two or more.

Examples of a method for preparing the dispersion (X) include a method in which an organic-inorganic composite hydrogel precursor composition, the polymerization initiator (F), the polymerization promotor (G), etc. are mixed in the same process; and a multi-liquid mixing method in which an organic-inorganic composite hydrogel precursor composition, a solution containing the polymerization initiator (F), and a solution containing the polymerization promotor (G) are prepared as separate dispersions or solutions and mixed immediately before use. From the viewpoints of dispersibility, storage stability, viscosity control, and the like, the multi-liquid mixing method is preferable.

As the solution containing the polymerization initiator (F), for example, an aqueous solution in which the polymerization initiator (F) and water are mixed may be used.

As the solution containing the polymerization promotor (G), for example, an aqueous solution in which the polymerization promotor (G) and water are mixed may be used.

An organic-inorganic composite hydrogel according to the present invention is obtained by polymerizing the water-soluble organic monomer (A) in the dispersion (X). The polymerization method is not particularly limited, and the polymerization can be performed by a known method. Specific examples thereof include radical polymerization by heating or under UV-light irradiation, and radical polymerization using redox reactions.

The polymerization temperature is preferably 10 to 80° C., and more preferably 20 to 80° C. When the polymerization temperature is 10° C. or higher, radical reactions can proceed as chain reactions, which is preferable. On the other hand, when the polymerization temperature is 80° C. or lower, polymerization can be performed without causing the water contained in the dispersion to boil, which is preferable.

Although the polymerization time varies depending on the types of the polymerization initiator (F) and the polymerization promotor (G), the polymerization is performed for several tens of seconds to 24 hours. In particular, in the case of radical polymerization by heating or using redox reactions, the polymerization time is preferably 1 to 24 hours, and more preferably 5 to 24 hours. When the polymerization time is 1 hour or more, the phosphonic acid-modified hectorite (B) and the polymer of the water-soluble organic monomer (A) can form a three-dimensional network, which is preferable. On the other hand, since polymerization reactions substantially complete within 24 hours, the polymerization time is preferably 24 hours or less.

Furthermore, since the organic-inorganic composite hydrogel precursor composition of the present invention has high viscosity and is polymerized also in an atmosphere other than nitrogen, the organic-inorganic composite hydrogel precursor composition may be poured into water and polymerized in water.

Since the organic-inorganic composite hydrogel precursor composition of the present invention can easily produce an organic-inorganic composite hydrogel even in water or in an air atmosphere, it can also be suitably used in site work applications, such as at civil engineering work sites and construction work sites.

Since the organic-inorganic composite hydrogel of the present invention can be used in industrial applications, such as civil engineering works and construction works, its breaking strength in tensile test in accordance with JIS K 6251:2010 is preferably 0.1 MPa or more.

### EXAMPLES

The present invention will be described in more detail below with reference to specific examples. Note that the viscosity is a value obtained by measuring a sample at 25° C. using a type B viscometer (“VISCOMETER TV-20” manufactured by Toki Sangyo Co., Ltd). The specific gravity is a value measured by a pycnometer method in accordance with JIS K6901.

### Example 1: Preparation of Organic-Inorganic Composite Hydrogel Precursor Composition (1)

Into a flat-bottomed glass container, 40 g of pure water, 63 g of refined glycerin, 4.8 g of a phosphonic acid-modified synthetic hectorite (“LAPONITE RDS” manufactured by BYK Japan KK), 1.44 g of a phosphonic acid-modified synthetic hectorite (“LAPONITE S-482” manufactured by BYK Japan KK), 20 g of dimethylacrylamide (hereinafter, abbreviated as “DMAA”), and 0.02 g of N,N′-methylenebisacrylamide were charged, followed by stirring to prepare a dispersion. Then, 10 g of cellulose nanofibers (“Cellish KY100G” manufactured by Daicel FineChem Ltd., hereinafter, abbreviated as “CNF (1)”) was added by degrees to the dispersion while stirring to prepare an organic-inorganic composite hydrogel precursor composition (1). The organic-inorganic composite hydrogel precursor composition (1) had an initial viscosity of 1,200 mPa·s and a specific gravity of 1.140.

### Evaluation of Storage Stability

The organic-inorganic composite hydrogel precursor composition (1) obtained above was sealed and stored in a thermostat vessel at 50° C. After one week, the composition was taken out of the thermostat vessel, and viscosity at 25° C. (viscosity after storage) was measured again, and storage stability was evaluated on the basis of the criteria described below.

∘: Viscosity after storage (mPa·s) was less than 200% of the initial viscosity (mPa·s).

X: Viscosity after storage (mPa·s) was 200% or more of the initial viscosity (mPa·s).

### Preparation of Dispersion (X)

Into a flat-bottomed glass container, 10 g of glycerin and 80 μL of tetramethylethylenediamine (hereinafter, abbreviated as “TEMED”) were charged, followed by stirring to prepare a homogeneous aqueous solution of TEMED.

Into a 200 mL glass beaker, 110 g of the organic-inorganic composite hydrogel precursor composition (1) obtained above was charged, and 0.5 g of sodium persulfate (hereinafter, abbreviated as “NPS”) was added thereto and stirred until it was dissolved. Furthermore, the aqueous solution of TEMED prepared above was gradually added thereto, and stirring was continued until homogeneous mixing was achieved to prepare a dispersion (X-1).

### Evaluation of Curability in Water

20 g of the dispersion (X-1) obtained above was quietly poured into a 200 ml glass beaker containing 100 g of water at 23° C. When the gelation time measured was reached, the state of gel formation was checked and evaluated in accordance with the evaluation criteria described below.

Note that the resulting hydrogel was not broken even when pushed with a glass rod.

⊙: The composition precipitated rapidly to form a hydrogel.

∘: Part of the composition was dispersed in water, but the composition that has precipitated formed a hydrogel.

X: The composition was dispersed in and diluted with water, and a hydrogel was not obtained.

### Evaluation of Water Pressure Resistance of Hydrogel

The aqueous solution (X-1) obtained above was filled into a hollow portion of a concrete cylinder with a diameter of 100 mm and a thickness of 100 mm, in which a central portion with a diameter of 26 mm was hollow, and left to stand for 24 hours. Thus, a filler for a concrete structure and a gel-concrete structure were obtained.

The structure was tested by a method in accordance with JIS A 1404:2015 (water permeability test for cement used for construction), in which pressure was applied, using water, to the entire top surface of the cylinder, and the water pressure at which no infiltration of water occurred into the bottom surface of the cylinder without breaking of the gel was measured and evaluated on the basis of the following criteria:

⊙: 0.4 MPa or more

∘: 0.2 MPa or more and less than 0.4 MPa

X: less than 0.2 MPa or unmeasurable because gel was brittle

### Evaluation of Rate of Mass Change of Hydrogel

Two glass plates with a thickness of 5 mm were bonded together with a 2-mm spacer therebetween to form a gap between the glass plates. The dispersion (X-1) obtained above was immediately flow-cast in the 2-mm gap and left to stand at room temperature for 24 hours to form an organic-inorganic composite hydrogel (1) with a thickness of 2 mm. After 24 hours, the state of the flow-cast liquid was checked, and it was found that a homogeneous, colorless, transparent organic-inorganic composite hydrogel sheet was obtained.

The organic-inorganic composite hydrogel sheet produced above was left to stand in a thermostat chamber at 25° C. for one month, and the rate of mass change (%) was measured and evaluated based on the criteria described below.

Rate of mass change (%)=(W₂−W₁)/W₁×100(%)

W₁: mass of sheet before being left to stand for one month

W₂: mass of sheet after having been left to stand for one month

### Example 2: Preparation of Organic-Inorganic Composite Hydrogel Precursor Composition (2)

An organic-inorganic composite hydrogel precursor composition (2) was prepared as in Example 1 except that 0.02 g of N,N′-methylenebisacrylamide used in Example 1 was changed to 0.5 g of polyethylene glycol diacrylate (“LIGHT ACRYLATE 4EG-A” manufactured by Kyoeisha Chemical Co., Ltd). The organic-inorganic composite hydrogel precursor composition (2) had an initial viscosity of 1,200 mPa·s and a specific gravity of 1.140.

An aqueous solution (X-2) and an organic-inorganic composite hydrogel were produced as in Example 1 except that the organic-inorganic composite hydrogel precursor composition (1) of Example 1 was changed to the organic-inorganic composite hydrogel precursor composition (2), and the evaluations were made.

### Comparative Example 1: Preparation of Composition (R1) for Comparison

An organic-inorganic composite hydrogel precursor composition (2) was prepared as in Example 1 except that the cellulose nanofibers added in Example 1 were not added. The organic-inorganic composite hydrogel precursor composition (R1) had an initial viscosity of 500 mPa·s and a specific gravity of 1.120.

An aqueous solution (RX-1) and a hydrogel were produced as in Example 1 except that the organic-inorganic composite hydrogel precursor composition (1) of Example 1 was changed to the composition (R1) for comparison, and the evaluations were made.

### Comparative Example 2: Preparation of Composition (R2) for Comparison

Into a flat-bottomed glass container, 90 g of pure water, 3.8 g of a phosphonic acid-modified synthetic hectorite (“LAPONITE RDS” manufactured by BYK Japan KK), 0.96 g of a phosphonic acid-modified synthetic hectorite (“LAPONITE S-482” manufactured by BYK Japan KK), and 20 g of DMAA were charged, followed by stirring to prepare a homogeneous, transparent aqueous solution. Then, 10 g of CNF (1) was added by degrees to the aqueous solution while stirring to prepare a composition (R2) for comparison. The composition (R2) for comparison had an initial viscosity of 10 mPa·s and a specific gravity of 1.024.

An aqueous solution (RX-2) and a hydrogel were produced as in Example 1 except that the organic-inorganic composite hydrogel precursor composition (1) of Example 1 was changed to the composition (R2) for comparison, and the evaluations were made.

The evaluation results obtained above are shown in Table 1.

TABLE 1

| | | | | | Comparative | Comparative |
|---|---|---|---|---|---|---|
| | | | Example 1 | Example 2 | Example 1 | Example 2 |
| Organic-inorganic composite hydrogel precursor composition | | | (1) | (2) | (R1) | (R2) |
| Composition | Water-soluble | DMAA | 20 | 20 | 20 | 20 |
| (g) | organic monomer | N,N′- | 0.02 | | 0.02 | |
| | (A) | methylenebis | | | | |
| | | acrylamide | | | | |
| | | Polyethylene | | 0.5 | | |
| | | glycol | | | | |
| | | diacrylate | | | | |
| | Phosphonic acid- | LAPONITE | 4.8 | 4.8 | 4.8 | 3.8 |
| | modified hectorite | RDS | | | | |
| | (B) | LAPONITE | 1.44 | 1.44 | 1.44 | 0.96 |
| | | S-482 | | | | |
| | Cellulose | CNF (1) | 10 | 10 | | 10 |
| | nanofibers (C) | | | | | |

| | | | | |
|---|---|---|---|---|
| Water (D) | 40 | 40 | 40 | 90 |
| Solvent (E) | 50 | 50 | 50 | |
| Mass ratio (D/E) | 40/50 | 40/50 | 40/50 | |

| | | | | |
|---|---|---|---|---|
| Storage stability | ◯ | ◯ | X | ◯ |
| Curability in water | ⊙ | ⊙ | ◯ | X |
| Water pressure resistance of hydrogel | ⊙ | ⊙ | ⊙ | ◯ |
| | 0.5 MPa | 0.5 MPa | 0.5 MPa | 0.2 MPa |
| Non-drying property of hydrogel (rate of mass change) | −10% | −10% | −10% | −80% |

It was confirmed that the organic-inorganic composite hydrogel precursor compositions of Examples 1 and 2 according to the present invention had excellent storage stability and curability in water and that the resulting hydrogels had excellent water pressure resistance and non-drying property.

On the other hand, in Comparative Example 1, which did not include cellulose nanofibers (C) that are an essential component of the present invention, it was confirmed that storage stability was insufficient.

On the other hand, in Comparative Example 2, which did not include a solvent (E) that is an essential component of the present invention, it was confirmed that curability in water was insufficient and that the resulting hydrogel had a poor non-drying property.

1. An organic-inorganic composite hydrogel precursor composition characterized by comprising a water-soluble organic monomer (A), a phosphonic acid-modified hectorite (B), cellulose nanofibers (C), water (D), and a solvent (E) having a volatility of 0.1 g or less per cm²·hr in an open system at 60° C., 1 atm (0.1 g/cm²·hr·60° C.·1 atm or less).

2. The organic-inorganic composite hydrogel precursor composition according to claim 1, wherein the mass ratio (D/E) of the water (D) to the solvent (E) is in the range of 60/40 to 20/80.

3. The organic-inorganic composite hydrogel precursor composition according to claim 1, wherein in the water-soluble organic monomer, a multifunctional monomer is contained in an amount of 0.01 to 0.5% by mass.

4. An organic-inorganic composite hydrogel characterized by being a reaction product of the organic-inorganic composite hydrogel precursor composition according to claim 1.

5. The organic-inorganic composite hydrogel precursor composition according to claim 2, wherein in the water-soluble organic monomer, a multifunctional monomer is contained in an amount of 0.01 to 0.5% by mass.

6. An organic-inorganic composite hydrogel characterized by being a reaction product of the organic-inorganic composite hydrogel precursor composition according to claim 2.

7. An organic-inorganic composite hydrogel characterized by being a reaction product of the organic-inorganic composite hydrogel precursor composition according to claim 3.

8. An organic-inorganic composite hydrogel characterized by being a reaction product of the organic-inorganic composite hydrogel precursor composition according to claim 5.
